(19) United States
(12) Patent Application Publication
(10) Pub. No.: US 2006/0016736 A1
(43) Pub. Date: Jan. 26, 2006

(54) Stand for mail sorting and other applications

(76) Inventor: Rory Garth Hocking, Porirua (NZ)

Correspondence Address: WELSH & KATZ, LTD, 120 S RIVERSIDE PLAZA, 22ND FLOOR, CHICAGO, IL, 60606, US

(21) Appl. No.: 10/524,797

(22) PCT Filed: Aug. 21, 2003
(86) PCT No.: PCT/NZ03/00185

§ 371 Date: Jul. 21, 2005

(30) Foreign Application Priority Data
Aug. 21, 2002 (NZ) 520900

(51) Int. Cl. B07C 5/00; G06K 9/00

(52) U.S. Cl. 209/584

(57) ABSTRACT

A mail sorting stand is of modular construction and includes two upright tubular frame members (1,1) and a shelving system consisting of a number of shelves (2) each of which comprises a lightweight tubular shelf frame. The shelves are connectable to the frame members by bracket parts (3) enabling the shelves to be mounted to and removed from the up right frame members from one side or from the front of the frame members. The frame members and preferably also the shelf frame parts are formed from lightweight metal tube, and the shelves include one or more trays (10) carried by the shelf frames.

### FIELD OF INVENTION

This invention relates to a mail sorting stand for use when sorting articles such as letters and the like in a postal delivery service, and which may have other applications.

### BACKGROUND

Known forms of mail sorting stands are described in NZ patent specification 23409, U.S. Pat. No. 5,590,794 and EP patent specification 635316, for example. Each stand generally consists of a framework providing at different heights rows of boxes or shelves which are partitioned to form slots or bins into which the mail is sorted by criteria such as street address. Typically a number of stands can be arranged together to increase the number of slots as required. An operator using a sorting stand is presented with one or more planar arrays of slots into which large numbers of mail items must be individually placed. The slots may be arranged and labelled in various ways. Slots which represent house numbers along a street may be distributed horizontally along a shelf, for example. The streets within a district may be distributed vertically on respective shelves.

### SUMMARY OF INVENTION

It is an object of the invention to provide an improved or at least alternative form of mail sorting stand, and variants of the stand of the invention may also have applications other than as a mail sorting stand.

In broad terms in one aspect the invention comprises a stand for mail sorting or other applications, which is of modular construction and includes one or more upright tubular frame members and a shelving system including one or more shelves each connectable to the frame member(s) by one or more bracket parts enabling the shelves to be mounted to and removed from the upright frame member(s) from one side or from the front of the frame members; wherein each shelf includes a tubular shelf frame carried by one or more of said bracket parts for supporting a tray, bin, basket or similar.

In broad terms in another aspect the invention comprises a stand for mail sorting or other applications, which is of modular construction and includes one or more upright tubular frame members and a shelving system including one or more shelves each connectable to the frame member(s) by one or more bracket parts enabling the shelves to be mounted to and removed from the upright frame member(s) from one side of the frame; wherein the bracket part(s) include an entry on one side enabling the one or more shelves to be mounted to and removed from the upright frame members from one side of the upright frame members.

The invention also provides a method of constructing or deconstructing a stand according to the previous aspect of the invention, the method including mounting or removing the shelf to or from the upright frame members from one side of the upright frame members.

In a preferred form the bracket parts include a hollow interior defined between an upper portion for engaging an upright member from the rear and a lower portion for engaging the upright member from the front when a shelf is mounted to the upright members, and an entry in the form of a longitudinally extending aperture on one side of the bracket part, so that the shelves may be mounted to the upright members by tilting a shelf upwardly from it's normal mounted position, moving the shelf on to the upright members from one side so that the tubular upright members pass through the entry passage into the brackets, and then dropping the shelf downwardly, to engage the shelf in position on to the upright members (and the reverse for removal).

Preferably the shelf members also include a lightweight tubular frame carried by the bracket parts for mounting a tray, bin(s), basket(s), or similar.

By tubular in relation to the upright frame member(s) is meant not only metal or plastic tube of a circular cross-section but also upright members having a hollow oval, square, or rectangular or other cross-sectional shape, and also in it's broadest sense the lightweight upright members forming the frame of the stand which may not have a closed tubular section but may have a U or C shaped cross-section shape for example.

In broad terms in another aspect the invention comprises a support part or bracket for supporting an item from an upright member, including a hollow interior defined between an upper portion for engaging the upright member from the rear and a lower portion for engaging the upright member from the front when the item is mounted to the upright member, and an entry in the form of a longitudinally extending aperture on one side of the support part, so that the item may be mounted to the upright member by tilting the support part upwardly from it's normal mounted position, moving the support part on to the upright member from one side so that the tubular upright member passes through the entry passage into the support part, and then dropping the item downwardly, to engage the item in position on to the upright member (and the reverse for removal).

In broad terms in another aspect the invention comprises a stand for mail sorting or other applications, which is of modular construction and includes one or more upright tubular frame members and a shelving system including one or more shelves each connectable to the frame member(s) by one or more bracket parts enabling the shelves to be mounted to and removed from the upright frame member(s) from one side or from the front of the frame members; wherein one or more of the shelves each carry on the shelf frame thereof a tray, bin, basket or similar comprising a base and a rear wall; wherein the tray, bin, basket or similar comprises two or more similar segments which connect together.

In broad terms in another aspect the invention comprises a tray, bin, basket or similar for use in a stand for mail sorting or other applications, the tray, bin, basket or similar including two or more similar segments which are interconnected, each segment including a base and a rear wall.

In broad terms in another aspect the invention comprises a segment for use in a tray, bin, basket or similar according to the previous aspect of the invention, the segment including a base and a rear wall, a protruding part on one side and a corresponding recess on the other side.

### BRIEF DESCRIPTION OF THE DRAWINGS

The invention is further described with reference to the accompanying drawings which show a preferred form mail sorting stand of the invention, by way of example and without intending to be limiting. In the drawings:

FIG. 1 is a perspective view of the preferred form mail sorting stand,

FIG. 2 is a view of the preferred form mail sorting stand from the front,

FIG. 3 is a view of the preferred form mail sorting standing stand from one side,

FIG. 4 is a view of the preferred form mail sorting stand from the rear,

FIG. 5 is a view of the preferred form mail sorting stand from above,

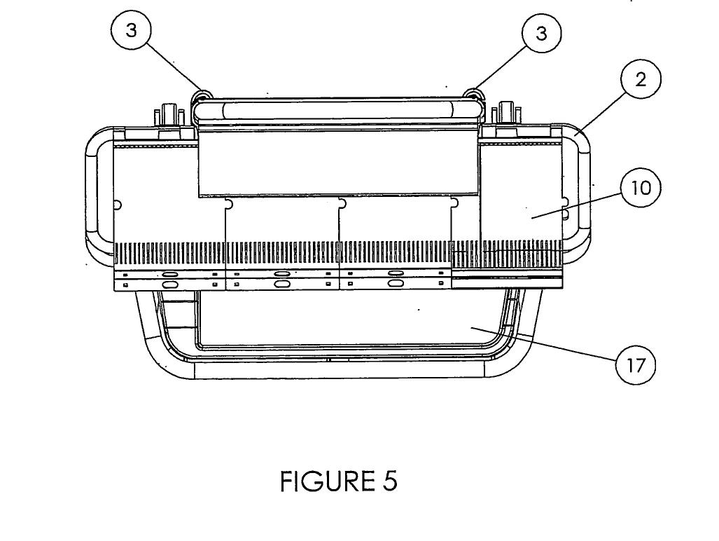

FIG. 6 is a view from one side of one shelf and bracket member of the preferred form mail sorting stand, in the direction of arrow A in FIG. 2,

FIG. 7 is a perspective view from a rear corner of a part of one side of the preferred form mail sorting stand,

FIG. 8 is a view from the rear showing engagement of a shelf via one of its support brackets on to the upright frame member of the mail sorting stand, and

FIG. 9 is a perspective view of one tray part of the preferred form mail sorting stand.

### DETAILED DESCRIPTION OF PREFERRED FORM

The drawings show a mail sorting stand but it will be apparent that a stand comprising a lightweight tubular frame supporting shelves as generally described may have other applications, and also that in such other applications the shelves instead of supporting flat trays may support baskets or bins or similar, or combinations of trays, baskets, or bins etc.

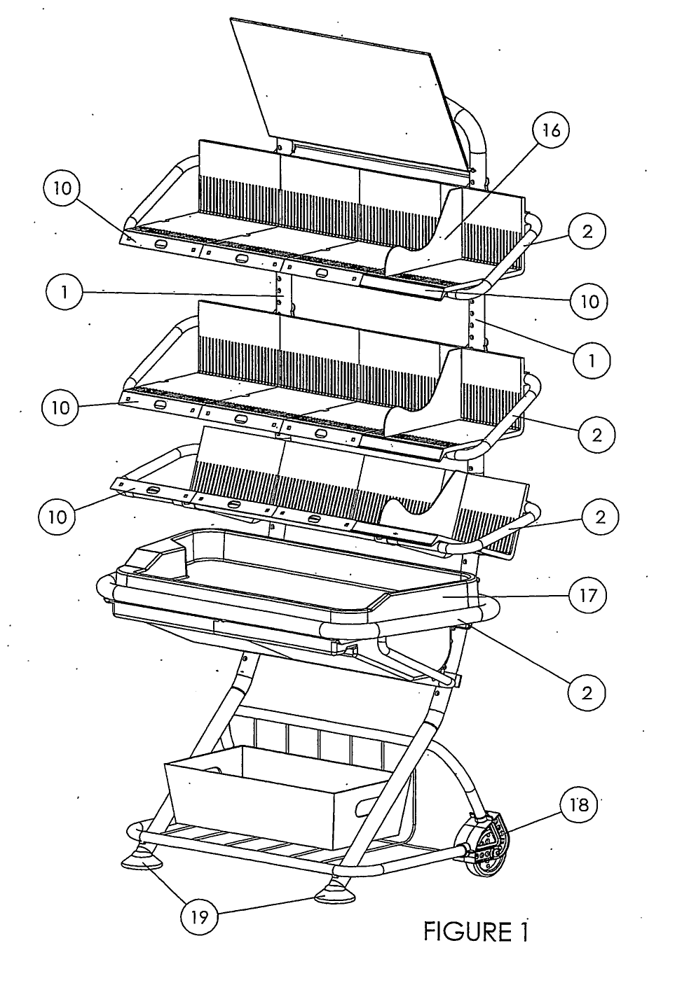

Referring to FIG. 1 the stand comprises a frame formed by upright tubular frame members 1, to which are mounted shelves as shown. In a preferred form the stand is of a lightweight tubular form as shown, and the shelves also each include a tubular frame 2 as shown.

Each shelf frame 2 carries two bracket parts 3 which are spaced apart to match the spacing of the frame uprights 1 by which the shelves are mounted to the uprights 1.

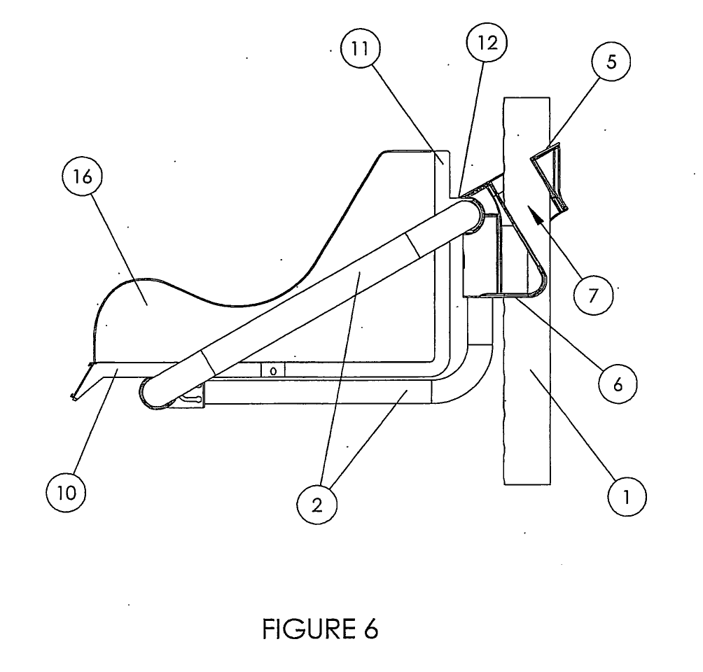

Referring to FIGS. 6 to 8 in particular, each bracket part 3 has a hollow interior 4, an interiorly curved upper portion 5 which engages the upright member 1 from the rear when the shelf is mounted to the uprights, and an interiorly curved lower portion 6 which engages the upright 1 from the front. Each bracket also has an entry in the form of a longitudinal passage 7 as shown.

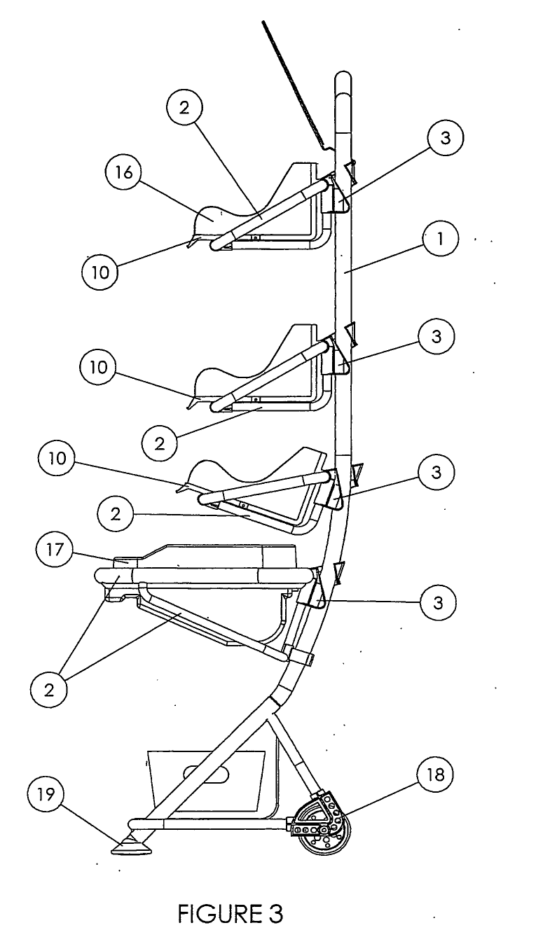

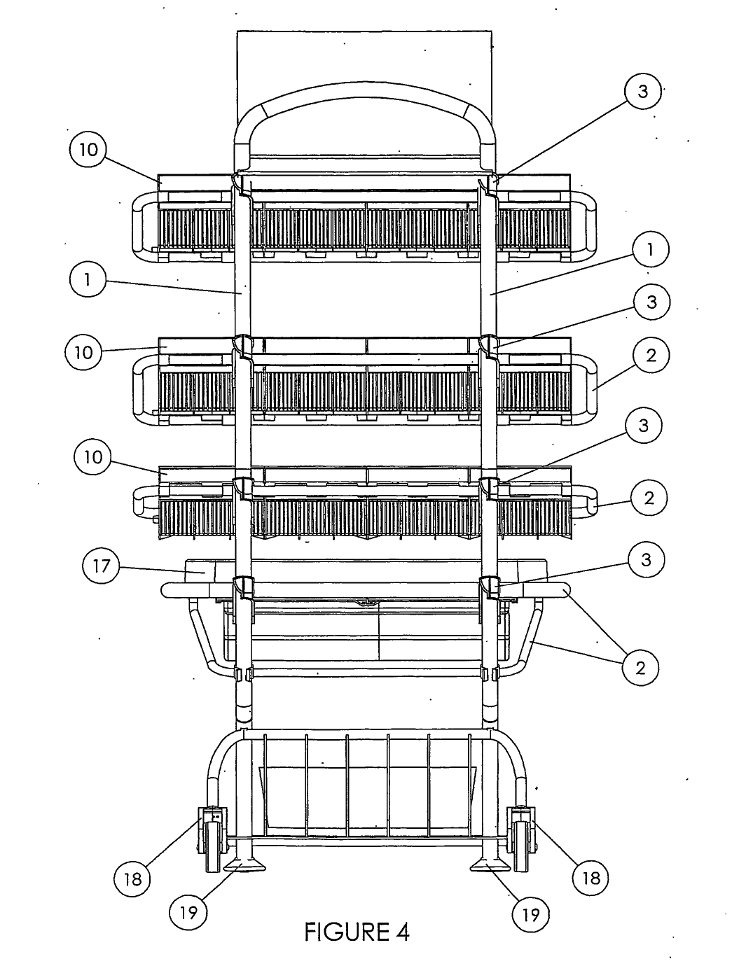

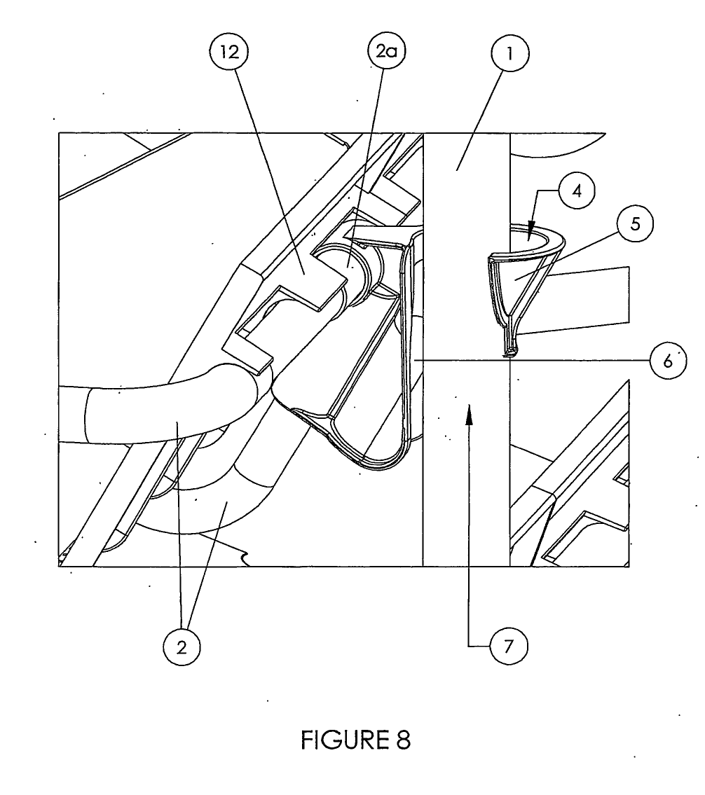

To mount a shelf to the upright members 1 of the stand the shelf is held tilted upwardly relative to FIG. 6, so that the side entry passage 7 of each bracket aligns with an upright member 1, and the shelf is moved from the side towards the upright member so that the upright members are engaged through the entry passages 7 and into the hollow interior of the brackets. The front of the shelf is then dropped ie pivoted downwardly, until the shelf has the position shown in FIG. 6, so that the rear and front portions of the bracket contact the upright member as shown. In FIGS. 1 to 4 and 7 the third shelf down from the top is shown after the bracket parts have been engaged on to uprights but with the shelf pivoted or dropped only partly towards it's mounted position. FIG. 8 shows the relative positions of the bracket part and an upright relative to one another after the shelf has been moved sideways to pass the upright member into the entry passage 7 of the bracket, but before dropping of the shelf downwardly. FIG. 6 shows the shelf and bracket from one side after the shelf has been dropped fully downwardly to mount the shelf on the uprights.

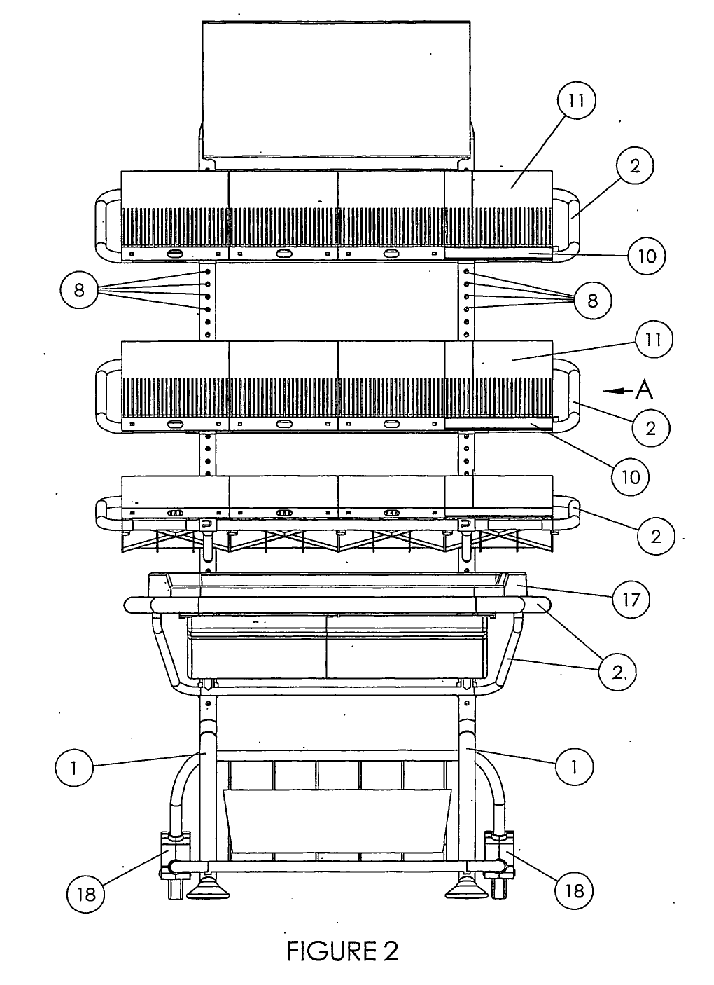

To further ensure that the shelves are securely located when mounted to the frame of the stand the upright members 1 may include a series of apertures or indentations 8 as shown in FIG. 2, into which a small protrusion (not shown) from the interior of the brackets may locate when the shelves are mounted to the frame of the stand.

Typically the bracket parts 3 are moulded from plastic and the tubular frame 2 of the shelves 2 is formed from for example powder coated or painted metal tube, the ends of which engage into bores in the bracket parts 3 as shown. The shelf frames 2 may be available in a variety of standard lengths to provide a variety of shelve lengths on a standard stand frame. The shelf frames may be provided in a variety of sizes to support trays or bins or baskets of a variety of dimensions.

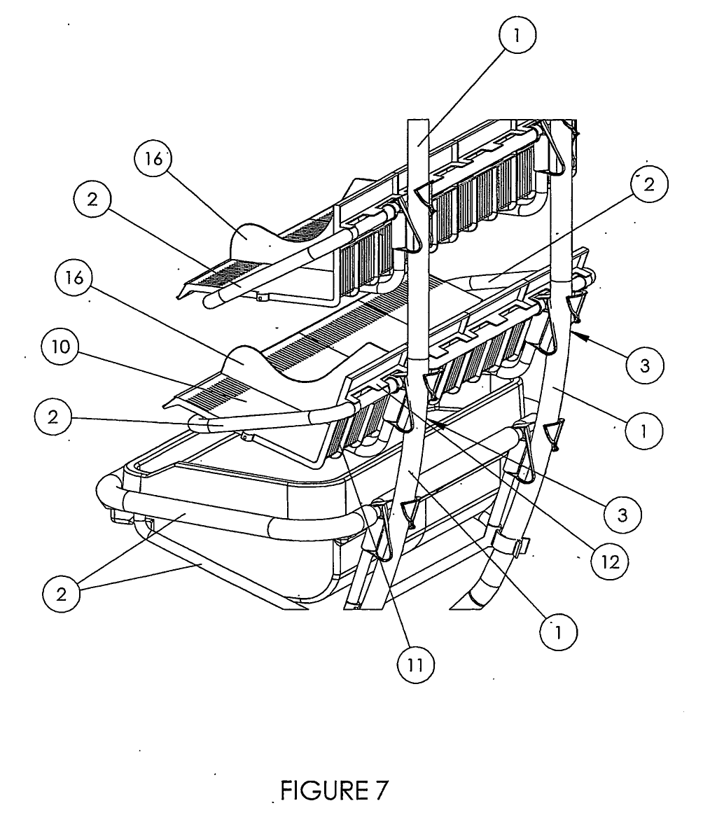

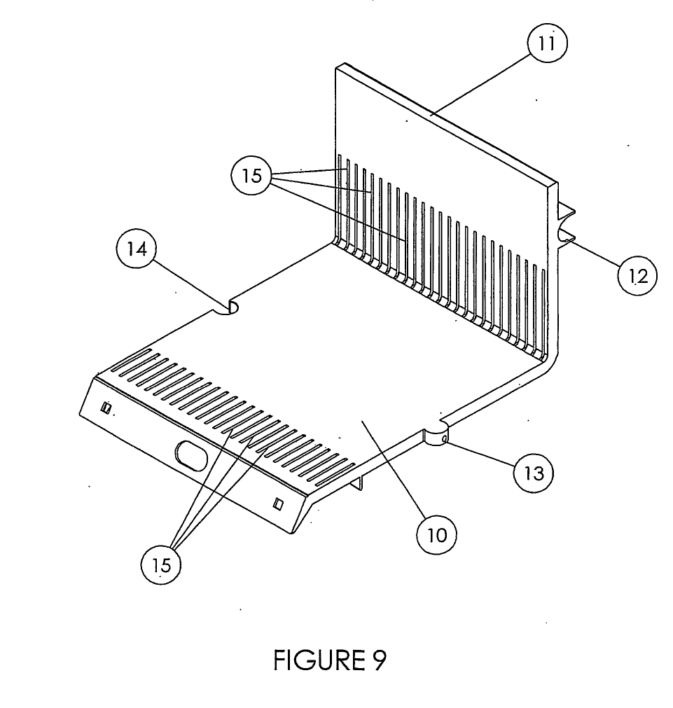

In a mail sorting application at least a number of the shelves support trays 10 as shown. In the preferred form the trays comprise a base 10 and rear wall 11 (see FIGS. 7 and 9). A part 12 is formed along the rear wall 11 which will clip on to a transverse rear part 2a of the tubular shelf frame as shown particularly in FIG. 8. The front part of the tray 10 sits on a forward transverse part of the shelf frame 2.

The trays 10 may be made in a variety of standard lengths, but are preferably formed as a series of interconnectable tray segments, one of which is shown in FIG. 9. Each segment includes a protruding part 13 on one side which can engage into a corresponding recess 14 on the edge of another tray segment, to couple a number of segments together to form a tray of the desired width. The trays will also typically be formed with a series of parallel slots 15 for mounting partitions 16 as shown.

Alternatively the shelves may support a shallow (or deeper) bin 17, or alternatively a tray or bin or basket in any other suitable form. Typically the trays and bins are moulded from plastic, but may alternatively be folded from sheet metal.

The apparatus is intended to be efficient and ergonomic so that a human operator is able to distribute mail items quickly by hand among a range of slots using natural movements.

One major benefit of the preferred form mail sorting apparatus as described is the ease with which shelves may be mounted and demounted from the backbone frame. Thus the stand or series of adjacent stands is easily reconfigurable with a different number of shelves or to position the shelves at different heights, with relative ease. Removal of one shelf or adjusting the heights of existing shelves to enable another shelf to be added, can be carried out quickly and readily. In at least some prior art in mail sorting stands the individual shelves mount over a backbone member from above in series, so that to remove a shelf lower down for example may require that the shelves above are first lifted up to the top of and from the backbone frame. Another benefit of the preferred form mail sorting stand as shown is its lightweight tubular and modular construction. As shown the stand may also include wheels 18 as well as feet 19 in which enable the stand to be moved wheelbarrow-like fashion.

In another form of stand of the invention similar benefits of ease of mounting and demounting of shelves from the backbone frame may be achieved by brackets or bracket parts which support shelves and which also engage tubular uprights but from the front, with the brackets having a rearwardly facing U-shape in cross-section, which engage onto the tubular uprights from the front, and a catch at the rear which closes and tightens the bracket about the uprights. Again to assist in securely locating the shelves the stand may include a similar arrangement of a protrusion, from the U-shaped interior of the bracket, which engages recesses or a toothed track or similar on the front of the uprights 1.

The preferred form stand described comprises two tubular uprights but in an alternative arrangement a single larger diameter tubular upright may be provided, which may be of a square, rectangular or oval cross-section for example, and each shelf may be supported by a single larger bracket or bracket part of a similar form which enables the shelf to be mounted and demounted from such a single tubular upright, generally in the same manner as described. Alternatively again a wider stand may comprise three spaced upright members 1 and each shelf may include three spaced brackets 3 or equivalent.

In the preferred form the brackets 3 and tubular shelf frame 2 are separate components which are fitted together, and then separate plastic moulded bracket or metal folder bracket trays or bins are fitted to the shelf frames 2 as described, but in alternative form the brackets or bracket parts may be integrally moulded (or die cast) with plastic or metal shelf frames. Alternatively again trays or bins of sufficient rigidity may have bracket parts generally as described formed integrally on an exterior of the rear wall.

As stated the preferred form stand of the invention is a mail sorting stand but a variants may have other applications, such as supporting parts of bins, a retail display shelving, and similar.

The foregoing describes the invention including a preferred form thereof. Alterations and modifications as will be obvious to those skilled in the art are intended to be incorporated within the scope thereof as defined in the accompanying claims.

1. A stand for mail sorting or other applications, which is of modular construction and includes one or more upright tubular frame members and a shelving system including one or more shelves each connectable to the frame member(s) by one or more bracket parts enabling the shelves to be mounted to and removed from the upright frame member(s) from one side or from the front of the frame members; wherein each shelf includes a tubular shelf frame carried by one or more of said bracket parts for supporting a tray, bin, basket or similar.

2. A stand according to claim 1 wherein the stand comprises two or more upright tubular frame members connected together at an upper part of the frame members.

3. A stand according to claim 2 wherein the stand comprises two upright tubular frame members and a connection between an upper part of the frame members, which are formed from a single length of tubular material in an inverted U shape.

4. A stand according to any one of the preceding claims, wherein the shelf frame(s) and bracket part(s) are separate components which can be fitted together.

5. A stand according to any one of the preceding claims wherein said tubular shelf frame includes parallel rear and front frame parts for supporting a separately formed tray, bin, basket or similar.

6. A stand according to claim 5 wherein the shelf frame is formed by a single length of tubular material formed into an open rectangular shape.

7. A stand according to claim 5 wherein the bracket part(s) which connect the shelf frame to the frame member(s) are carried by the rear shelf frame part.

8. A stand for mail sorting or other applications, which is of modular construction and includes one or more upright tubular frame members and a shelving system including one or more shelves each connectable to the frame member(s) by one or more bracket parts enabling the shelves to be mounted to and removed from the upright frame member(s) from one side or from the front of the frame members; wherein one or more of the shelves each carry on the shelf frame thereof a tray, bin, basket or similar comprising a base and a rear wall; wherein the tray, bin, basket or similar comprises two or more similar segments which connect together.

9. A stand according to claim 8 wherein one or more formations on the back of the rear wall of the tray, bin, basket or similar clip-connect to the rear shelf frame part and the underside of the base of the tray, bin, basket or similar is supported by the front shelf frame part.

10. A stand according to any one of claims 8 to 9 including partitions for dividing the tray, bin, basket or similar across the stand.

11. A stand according to claim 10 wherein the tray, bin, basket or similar is formed with a plurality of apertures spaced along its length into which said partitions may be engaged to connect the partitions to the tray, bin, basket or similar.

12. A stand for mail sorting or other applications, which is of modular construction and includes one or more upright tubular frame members and a shelving system including one or more shelves each connectable to the frame member(s) by one or more bracket parts enabling the shelves to be mounted to and removed from the upright frame member(s) from one side of the frame; wherein the bracket part(s) include an entry on one side enabling the one or more shelves to be mounted to and removed from the upright frame members from one side of the upright frame members.

13. A stand according to claim 12 wherein the bracket parts include a hollow interior defined between an upper portion for engaging an upright frame member from the rear and a lower portion for engaging the upright frame member from the front when a shelf is mounted to the upright member(s), and said entry in the form of a longitudinally extending aperture on one side of the bracket part, so that the shelves may be mounted to the upright frame member(s) by tilting a front of a shelf upwardly relative to it's normal position when mounted to the upright frame member(s), moving the shelf on to the upright member(s) from one side so that the tubular upright member(s) pass through the entry passage into the bracket(s), and then dropping the front of the shelf downwardly, to engage the shelf in position on the upright frame member(s) (and the reverse for removal).

14. A stand according to claim 13 wherein the upright frame member(s) include a series of apertures or indentations along the length(s) thereof into which a protrusion from the interior of the bracket part(s) may locate when shelves are mounted to the upright frame members.

15. A stand according to any one of the preceding claims, wherein the stand is a mail sorting stand, including two upright tubular frame members, wherein each shelf includes a lightweight tubular shelf frame and wherein the upright frame members and shelf frames are formed from lightweight metal tube, and also including one or more tray(s), bin(s), basket(s) or similar carried by the shelf frames.

16. A mail sorting stand according to claim 15 wherein the bracket parts and the tray, bin, basket or similar are formed from a plastic material.

17. A support part or bracket for supporting an item from an upright member, including a hollow interior defined between an upper portion for engaging the upright member from a rear and a lower portion for engaging the upright member from a front when the item is mounted to the upright member, and an entry in the form of a longitudinally extending aperture on one side of the support part, so that the item may be mounted to the upright member by tilting the support part upwardly from it's normal mounted position, moving the support part on to the upright member from one side so that the tubular upright member passes through the entry passage into the support part, and then tilting the item downwardly, to engage the item in position on the upright member (and the reverse for removal).

18. A tray, bin, basket or similar for use in a stand for mail sorting or other applications, the tray, bin, basket or similar including two or more similar segments which are interconnected, each segment including a base and a rear wall.

19. A tray, bin, basket or similar according to claim 18, wherein each adjacent pair of segments are interconnected by a protruding part on a side of a first one of the adjacent segments which engages into a corresponding recess on a side of a second one of the adjacent segments.

20. A tray, bin, basket or similar according to claim 19 wherein each segment includes a protruding part on one side and a corresponding recess on the other side.

21. A segment for use in a tray, bin, basket or similar according to any of claims 18 to 20, the segment including a base and a rear wall, a protruding part on one side and a corresponding recess on the other side.

22. A method of constructing a stand according to claim 12, the method including mounting the shelf to the upright frame members from one side of the upright frame members.

23. A method according to claim 22 wherein the mounting of the shelf to the upright frame members includes the steps of:
tilting the bracket upwardly so that the longitudinally extending aperture on the side of the bracket part aligns with the side of the upright frame member;
moving the bracket on to the upright frame member from one side so that the tubular upright frame member passes through the entry passage in the bracket; and
tilting the bracket downwardly so that the lower portion of the bracket and the upper portion of the bracket engage the shelf in position on the upright frame member.

24. A method of deconstructing a stand according to claim 12, the method including removing the shelf from the upright frame members from one side of the upright frame members.

25. A method according to claim 24 wherein the removing of the shelf from the upright frame members includes the steps of:
tilting the bracket upwardly so that the longitudinally extending aperture on the side of the bracket part aligns with the side of the upright frame member;
moving the bracket away from the upright frame member from one side so that the tubular upright frame member passes through the entry passage in the bracket.
